(19) United States
(12) Patent Application Publication
(10) Pub. No.: US 2016/0035046 A1
(43) Pub. Date: Feb. 4, 2016

(54) INFLUENCER SCORE

(71) Applicant: Linkedln Corporation, Mountain View, CA (US)

(72) Inventors: Abhishek Gupta, San Francisco, CA (US); Zang Li, Milpitas, CA (US); Anmol Bhasin, Los Altos, CA (US); Annabel Fang Liu, Los Altos, CA (US); Sachin Rekhi, Mountain View, CA (US); Angela Yoonjeong Yang, San Francisco, CA (US)

(21) Appl. No.: 14/572,390

(22) Filed: Dec. 16, 2014

Related U.S. Application Data
(60) Provisional application No. 62/031,808, filed on Jul. 31, 2014.

(51) Int. Cl. G06Q 50/00; G06F 17/30; G06Q 30/02; H04L 29/08

(52) U.S. Cl. CPC G06Q 50/01; H04L 67/22; G06F 17/3053; G06Q 30/0201

(57) ABSTRACT

A method and system are shown for identifying the most influential members of a social network. The social networking system receives a request to rank a plurality of members of a social networking system based on the influence held by each of the plurality of members. For a respective member in the plurality of members of the social networking system, the social networking system analyzes member interactions of the respective member on the social networking system and generates an influencer score for the respective member based on the analysis of member interactions through the social networking system. The social networking system orders two or more members in the plurality of members of the social networking system based on the influencer scores associated with the two or more members.

### RELATED APPLICATIONS

This application claims the benefit of priority to U.S. Provisional Application Ser. No. 62/031,808, filed Jul. 31, 2014, which is incorporated herein by reference in its entirety.

### TECHNICAL FIELD

The disclosed implementations relate generally to the field of social networks and in particular to a system for ranking highly influential members of a network.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly. Similarly, online social networking sites allow members to build and maintain personal and business relationships in a much more comprehensive and manageable manner.

One important application of new computer technologies is improving connections in the world of sales and commerce. Sales professionals (e.g., people or companies that derive their income from selling goods or products to other individuals or companies) rely on finding new customers to grow and develop both their own careers and the companies that they work for. However, once a new potential customer organization is identified, it can be very difficult to determine a specific person within the organization to contact. Ideally, people interested in affecting the actions of organizations prefer to talk to the most influential persons within that organization.

However, if can be difficult to evaluate a particular person's level of influence in an organization. Traditional analysis of influence in an organization has relied on seniority and job title, both of which are indirect measures and poor indicators of true influence in an organization. Networked computer systems can collect and process large amounts of data to streamline and enhance the system for evaluating the influence of a member of an organization.

### DESCRIPTION OF THE DRAWINGS

Some implementations are illustrated by way of example and not limitation in the figures of the accompanying drawings, in which:

FIG. 1 is a network diagram depicting a client-server system that includes various functional components of a social networking social networking system, in accordance with some implementations.

FIG. 2 is a block diagram illustrating a client system, in accordance with some implementations.

FIG. 3 is a block diagram illustrating a social networking system, in accordance with some implementations.

FIG. 4 is a member interface diagram illustrating an example of a member interface, according to some implementations.

FIG. 5A is a flow diagram illustrating a process for identifying influential members in a social networking system, in accordance with some implementations.

FIG. 5B is a flow diagram illustrating a process for identifying influential members in a social networking system, in accordance with some implementations.

FIG. 5C is a flow diagram illustrating a process for identifying influential members in a social networking system, in accordance with some implementations.

FIG. 6 is a block diagram illustrating architecture of software, which may be installed on any one or more of devices, in accordance with some implementations.

FIG. 7 is a block diagram illustrating components of a machine, according to some example embodiments.

Like reference numerals refer to corresponding parts throughout the drawings.

### DETAILED DESCRIPTION

The present disclosure describes methods, systems and computer program products for using existing member profile and activity data to determine member influence levels within an organization. In the following description, for purposes of explanation, numerous specific details are set forth to provide a thorough understanding of the various aspects of different implementations. It will be evident, however, to one skilled in the art, that the any particular implementation may be practiced without all of the specific details and/or with variations, permutations, and combinations of the various features and elements described herein.

The social networking system uses member interactions with other members and with the social networking system to identify which members of an organization are the most influential. In some example embodiments, the social networking system receives a request to identify which members in a plurality of members associated with a particular organization are the most influential. In some example embodiments, the request is sent from a member and in other examples, the request is automatically generated when a member loads a page from the social networking system. The social networking system generates an influencer score for each member in the plurality of members. In some example embodiments, the influence score is also known as a decision maker score and represents the likelihood that a particular member is a key decision maker in an organization.

The social networking system uses information stored about the interactions of members to identify one or more members who have influencer scores above a predetermined threshold (e.g., that are determined to be highly influential.) In some example embodiments, influencer scores are generated by combining several component scores. Potential component scores include, but are not limited to, a popularity score, an authority score, and a connectedness score.

In some example embodiments, a popularity score for a first member is generated based on the ratio between the number of unique members who view the first member's profile and the number of unique profiles the first member views. In some example embodiments, members with a higher ratio have a higher popularity score.

In some example embodiments, an authority score is determined based on a ratio of incoming messages and connection requests for a member to outgoing messages and connection requests. In general, a member that has more incoming messages than outgoing messages has a higher authority score within an organization than a member that does not.

A connectedness score is based on how a member fits into a social graph. If a particular member serves as a connection point for a large number of members, then that particular member will have a higher connectedness score than a member that does not serve as a connection point between many members.

The members are then ranked in order of their associated influencer score. The social networking system then selects one or more members based on the ranking. Based on the request, these selected members are returned to a client system for display to a member. In some example embodiments, the contact information or other contact means are also transmitted to the client system for display.

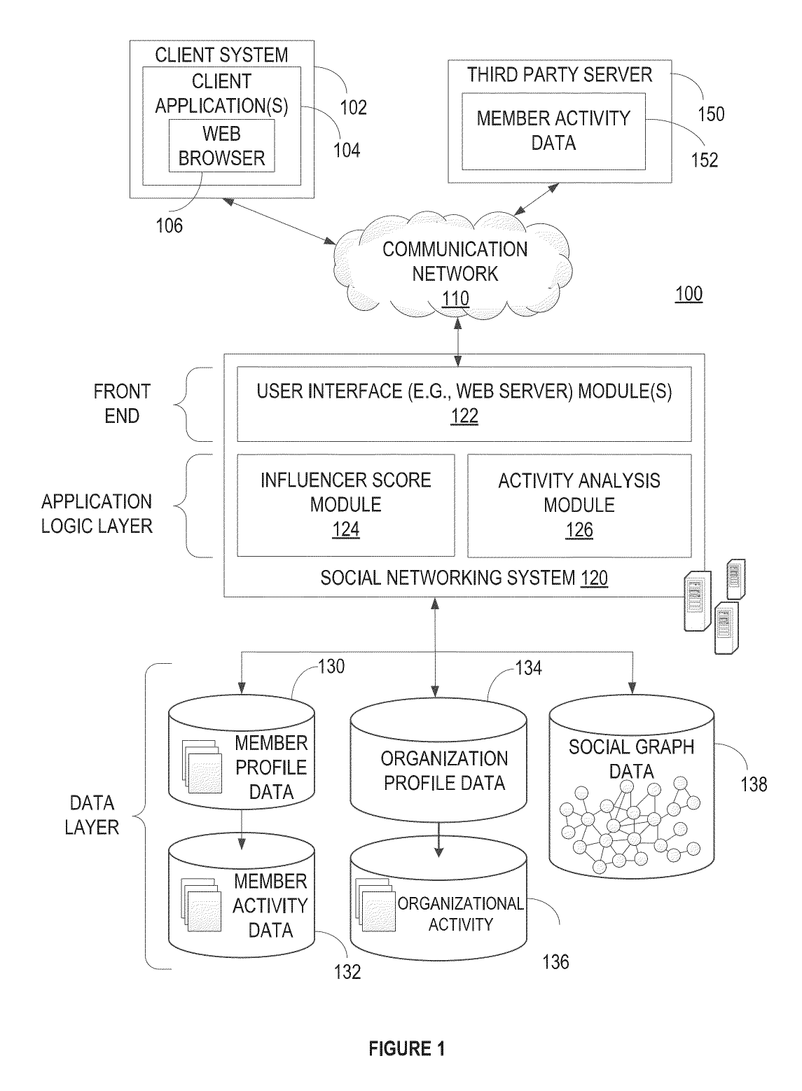

FIG. 1 is a network diagram depicting a client-social networking system 100 that includes various functional components of a social networking system 120, in accordance with some implementations. The client-social networking system 100 includes one or more client systems 102, a social networking system 120, and one or more other third party servers 150. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some implementations, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some implementations, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120. In some implementations, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service make be completely distinct computer systems.

In some implementations, the client system 102 sends a request to the social networking system 120 for a webpage associated with the social networking system 120 (e.g., the client system 102 sends a request to the social networking system 120 for an updated web page associated with an organization). For example, a member of the client system 102 logs onto the social networking system 120 and clicks to view updates to an organizational homepage. In response, the client system 102 receives the updated data (e.g., news items, recommendations, leads) and displays them on the client system 102.

In some implementations, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various implementations have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various implementations are by no means limited to this architecture.

As shown in FIG. 1, the front end consists of a user interface module (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, member activity data 132 (e.g., data describing member interactions with the social networking system 120 or with other members throughout the social networking system 120, organization profile data 134, organizational activity data 136 (e.g., data that describes activities from an organizational point of view including, but not limited to, staffing changes, product releases, business plan changes, business relationships between members of the social networking system such as seller and customer relationships, and so on), and a social graph database 138, which is a particular type of database that uses graph structures with nodes, edges, and properties to represent and store data. Of course, with various alternative implementations, any number of other entities might be included in the social graph (e.g., companies, organizations, schools and universities, religious groups, non-profit organizations, and any other group), and as such, various other databases may be used to store data corresponding with other entities.

Consistent with some implementations, when a person initially registers to become a member of the social networking system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, memberships with third party servers 150, and so on. This information is stored, for example, in the member profile database 130.

In some implementations, the member profile data 130 includes member activity data 132. In other implementations, the member activity data 132 is distinct from, but associated with, the member profile data 130. The member activity data 132 stores activity data for each member of the social networking system 120. Member activity data includes, but is not limited to, the dates and times the member logs onto or off of the system, information and profiles viewed by the member on the social networking system 120 (e.g., pages associated with people, organizations, brands, and or companies, jobs listings), communications made with other members (posts or messages), saved lead recommendations, sent and received connection requests, and posts made by the member.

The organization profile data 134 also stores data related to organizations on the social networking system 120 and their members. Thus, members of the social networking system 120 may be associated with employers, customers, and other organizations such as schools, professional groups, and non-profit organizations (e.g., based on interests, family connections, schools, employers, etc.).

Once registered, a member may invite other members, or be invited by other members, to connect via the network service. A “connection” may include a bi-lateral agreement by the members, such that both members acknowledge the establishment of the connection. Similarly, with some implementations, a member may elect to “follow” another member. In contrast to establishing a “connection,” the concept of “following” another member typically is a unilateral operation and, at least with some implementations, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 also includes organizational activity data 136. Organizational activity includes information that details changes within a plurality of organizations, including, but not limited to, changes in the staff of the organization, changes in an organization's location, changes in an organization's business, and any other information related to an organization.

In some example embodiments, the member profile data 130 includes sales relationships for one or more members. For example, customer data includes a list of customers, target companies, previous sales, sales preferences, job description, and any other data relevant to sales professionals.

The social networking system 120 may provide a broad range of other applications and services that allow members the opportunity to share and receive information, often customized to the interests of the member. In some implementations, the social networking service may include a photo sharing application that allows members to upload and share photos with other members. As such, at least with some implementations, a photograph may be a property or entity included within a social graph. With some implementations, members of a social networking service may be able to self-organize into groups, or interest groups, organized around a subject matter or topic of interest. In some implementations, the data for a group may be stored in a database. When a member joins a group, his or her membership in the group will be reflected in the organization activity data, the member activity data, and the social graph data stored in the social graph database 138.

With some implementations, members can be affiliated with a particular organization in an employee/employer relationship. The social networking system 120 will store this information in the member profile data 130, the organization profile data 134, and potentially, in the organizational activity data 136. For example, member A lists Company C as an employer. This is stored in the member profile associated with member A and in the organization profile of Company C. If members of the social networking service indicate an affiliation with a company at which they are employed, then news and events pertaining to the company are automatically communicated to the members. With some implementations, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the social graph database 138.

In some implementations, the application logic layer includes various application server modules, which, in conjunction with the user interface module(s) 122, generates various user interfaces (e.g., web pages) with data retrieved from various data sources in the data layer. With some implementations, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize an influencer score module 124 or an activity analysis module 126 may be separately implemented in their own application server modules.

In addition to the various application server modules, the application logic layer includes an influencer score module 124 and an activity analysis module 126. As illustrated in FIG. 1, with some implementations, the influencer score module 124 is implemented as a service that operates in conjunction with various application server modules. For instance, any number of individual application server modules can invoke the functionality of the influencer score module 124 to determine how influential a particular member is. However, with various alternative implementations, the influencer score module 124 may be implemented as its own application server module such that it operates as a stand-alone application. With some implementations, the influencer score module 124 includes or has an associated publicly available API that enables third-party applications to invoke the functionality of the influencer score module 124.

Generally, the influencer score module 124 calculates an influencer score for one or more members of the social networking service. An influencer score is a representation of how influential a member of an organization is relative to other members of the organization. Thus, members with higher influencer scores are more likely to affect the outcome of decisions that the organization makes including how the organization spends some or all of its budget, what projects an organization takes on, who and when new people are hired, stands taken by the organization on social or political issues, and other decisions organizations make.

In some example embodiments, the influencer score is represented as a number. For example, an influencer score can be a value between 0 and 1.0, where scores closer to 1 have more influence and scores close to 0 have less influence. In other embodiments, influencer scores are organized into one or more discrete groups (e.g., “Highly influential,” “Moderately influential,” “Not influential”), and members are grouped into one of the discrete groups.

In some example embodiments influencer scores are generated by analyzing actions (or interactions) taken by the members of a social networking service through the service or through a third party service of some kind. The influencer score module 124 stores many categories of information (e.g., classifiers) including messages, page views, connection invitations, replies, time spent interacting with the social networking system, and any other relevant data.

In some example embodiments the categories of information collected are very specific. For example, social networking system 120 stores information describing not only that a message was sent or received by also information about the sender/receiver. Thus, the social networking system 120 tracks the number of messages from a person in sales or in a human resources department. Additionally, the social networking system 120 can track whether the interactions are from another member with a high influencer score. For example, a member with a profile page that is often visited by members with high influencer scores may get a higher influencer score than a member whose profile is visited slightly more often but by members with very low influencer scores.

In some example embodiments, the influencer score is made by combining one or more component scores into a single weighted score. In some example embodiments, component scores include, but are not limited to, a popularity score, an authority score, and a connectedness score. These component scores are then combined to form an overall influencer score. In some example embodiments, component scores may relate to specific functions in the organization. For example, a member may have a high influencer score in human resources, meaning that they have influence on the hiring of new people, but a relatively low influencer score in buying supplies. Thus, the aggregate influencer score is between the two values. However, some requests are only concerned with one aspect of the influencer score. So if a request specifies that the only component that is of interest is the buying of supplies, the buying supplies component of the influencer score is the only component considered for responding to that request.

A popularity score component reflects how much interest there is in a particular member. This can be measured in one or more ways. One potential tool for generating a popularity score for a respective member is to determine a ratio of unique members that view the respective member's profiles to the number of unique member profiles viewed by the respective member. For example, if 2000 unique members view the profile of Member A and Member A only views three unique profiles, Member A will have a relatively high popularity score. Conversely, if Member B's profile is only viewed by seven unique members and Member B views the profiles of 30 members, Member B's popularity score will be relatively low.

Members whose profiles are viewed at a significantly higher rate than they themselves visit other profiles are determined to have a higher popularity score. In some example embodiments, having profile views from members who have high popularity scores or influencer scores themselves can result in an increased popularity score.

In some example embodiments the popularity score can measure a more specific popularity level. For example, a popularity score within an organization can be measured by only considering profile views from and to other members of the organization. For example, member A may have a higher overall popularity score than member B, but if member A's profile is only rarely visited by members associated with Organization C (e.g., an employer), and member B's profile is frequently viewed by members associated with Organization C, then member B's popularity score within the organization will be higher.

An authority score component reflects the relative authority a member has within an organization. This can be measured in multiple ways. In some example embodiments, an authority score is measured by calculating the ratio of incoming messages or connection invitations to outgoing messages or connection invitations, with the idea being that members with a great deal of authority are often inundated with requests and they have to be selective in deciding which to respond to.

In some example embodiments, more specific authority scores can reflect authority within a particular field. For example, the influencer score module 124 can determine only the incoming and outgoing messages/requests from and to sales people. This will give an authority score within a sales context. Then a member is able to request a list of influencers with regard only to the sales component of an influence score and in return receive rankings that only take into account the sales component of the authority score while ignoring the overall authority scores.

A connectedness score component reflects the degree to which a member helps connect members of within an organization. A connectedness score component reflects the betweenness centrality of a given member. Betweenness centrality is a measure of the degree to which a respective member of the social networking system 120 acts as part of the shortest path between two other members. For example, if a member has a lot of connections in a social graph 140, then it is more likely that they are part of the shortest chain between any two members.

Generally, the influencer score module 124 calculates an influencer score for one or more members of the social networking service. An influencer score is a representation of how influential a member of an organization is relative to other members of the organization. Thus, members with higher influencer scores are more likely to affect the outcome of decisions that the organization makes including how the organization spends some or all of its budget, what projects an organization takes on, who and when new people are hired, stands taken by the organization on social or political issues, and other decisions organizations make.

The activity analysis module 126 gathers, organizes, and analyzes data concerning the activities that members take through the social networking system 120. For example, the activity analysis module 126 tracks all messages, profile views, connection invitations, and any other interactions for each member of the social networking system 120 through the system or via a third party system. The activity analysis module 126 also records and analyzes information about the members that take these actions such that a page view from a member of a sales team is recorded different than a page view from a person seeking a job.

This information is all collected and analyzed to help the influencer score module 124 generate influencer scores.

When the social networking system 120 receives a request for influencer information (e.g., the top five influencers in human resources at organization A), the activity analysis module 126 is able to access only the relevant interaction information and send it to the influencer score module 124. The influencer score module 124 then generates influence scores for a plurality of members.

The social networking system (e.g., system 120 in FIG. 1) then sorts or orders the members based on the calculated influencer score and transmits the data to the requesting client system (e.g., system 102 in FIG. 1).

One or more third-party servers 150 connect to the social networking system (e.g., system 120 in FIG. 1) through a communication network 110. A third party server may also include member activity data 152 (e.g., the activity of members of the social networking system (e.g., system 120 in FIG. 1) when they interact through a third party server 150.

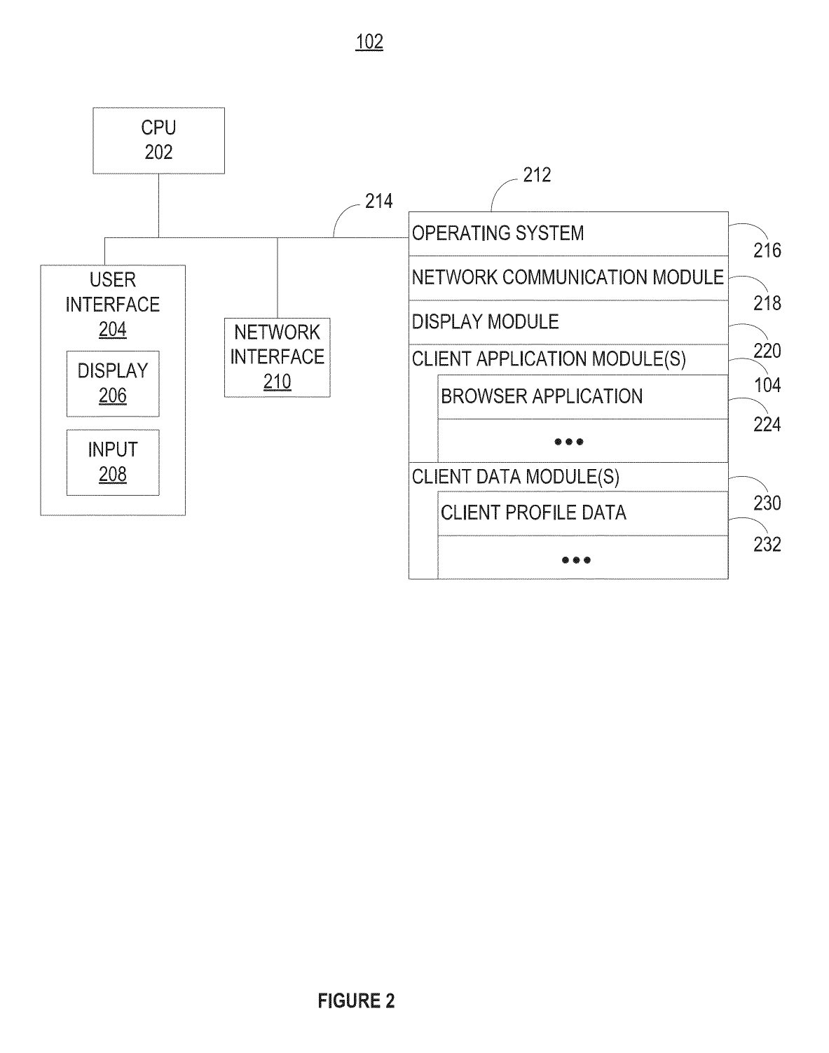

FIG. 2 is a block diagram illustrating a client system 102, in accordance with some implementations. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some implementations, memory 212 or the computer readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other WANs, LANs, metropolitan area networks (MANs), etc.;
a display module 220 for enabling the information generated by the operating system 216 and client applications 104 to be presented visually on the display 206;
one or more client applications 104 for handling various aspects of interacting with the social network social networking system (FIG. 1, 120), including but not limited to:
   a browser application 224 for requesting information from the social networking system 120 (e.g., product pages and member information) and receiving responses from the social networking system 120; and
a client data module 230, for storing data relevant to the clients, including but not limited to:
   client profile data 232 for storing profile data related to a member of the social network social networking system 120 associated with the client system 102.

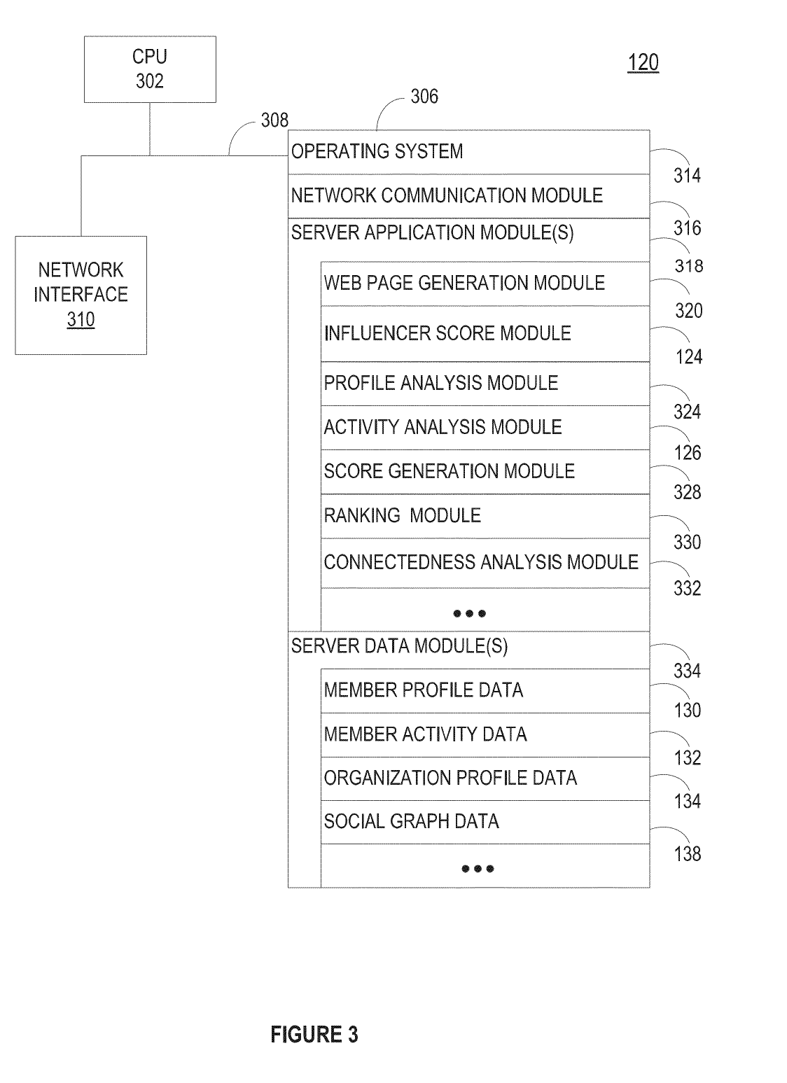

FIG. 3 is a block diagram illustrating a social networking system 120, in accordance with some implementations. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some implementations, memory 306 or the computer readable storage medium of memory 306 stores the following programs, modules, and data structures, or a subset thereof:
an operating system 314 that includes procedures for handling various basic system services and for performing hardware dependent tasks;
a network communication module 316 that is used for connecting the social networking system 120 to other computers via the one or more communication network interfaces 310 (wired or wireless) and one or more communication networks, such as the Internet, other WANs, LANs, MANs, and so on;
one or more server application modules 318 for performing the services offered by social networking system 120, including but not limited to:
   a web page generation module 320 for receiving requests from members of the social networking system 120 and, in response, generating web pages responsive to those requests, including but not limited to requests to view a member profile, requests to see an activity wall, requests to see social graph data, requests to see relative influence rankings, and so on;
   an influencer score module 124 for generating influencer scores for one or more members of a social networking system 120 based on information collected about member interactions on a social network;
   a profile analysis module 324 for analyzing a member's profile to determine whether the member is a good match for a requesting member based on the information stored in the member profile including but not limited to, the member's employer, location, seniority, job title, work history, interests, skills, social graph, and so on;
   an activity analysis module 126 for tracking the activities of multiple members of the social networking system 120 (e.g., any member that agrees to activity tracking) and then using those stored activities to infer information about each tracked member;
   a score generation module 328 for generating an influencer score for one or more members;
   a ranking module 330 for ordering a plurality of members based on their associated influence score; and
   a connectedness analysis module 332 for determining how connected a member is based on how often they are part of the shortest connections between to members; and
server data modules 334, holding data related to social network social networking system 120, including but not limited to:
   member profile data 130 including both data provided by the member person who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, and overall trend data for the social networking system 120, and so on;
   member activity data 132 including data representing any interaction the member has with the social networking system 120, including but not limited to log on/log off events, messages, invites, page views, etc.;
   organization profile data 134 including data describing one or more organizations (e.g., companies, corporations, non-governmental organizations, government entities, and so on), and
   social graph data 138 including data that represents members of the social networking system 120 and the social connections between them.

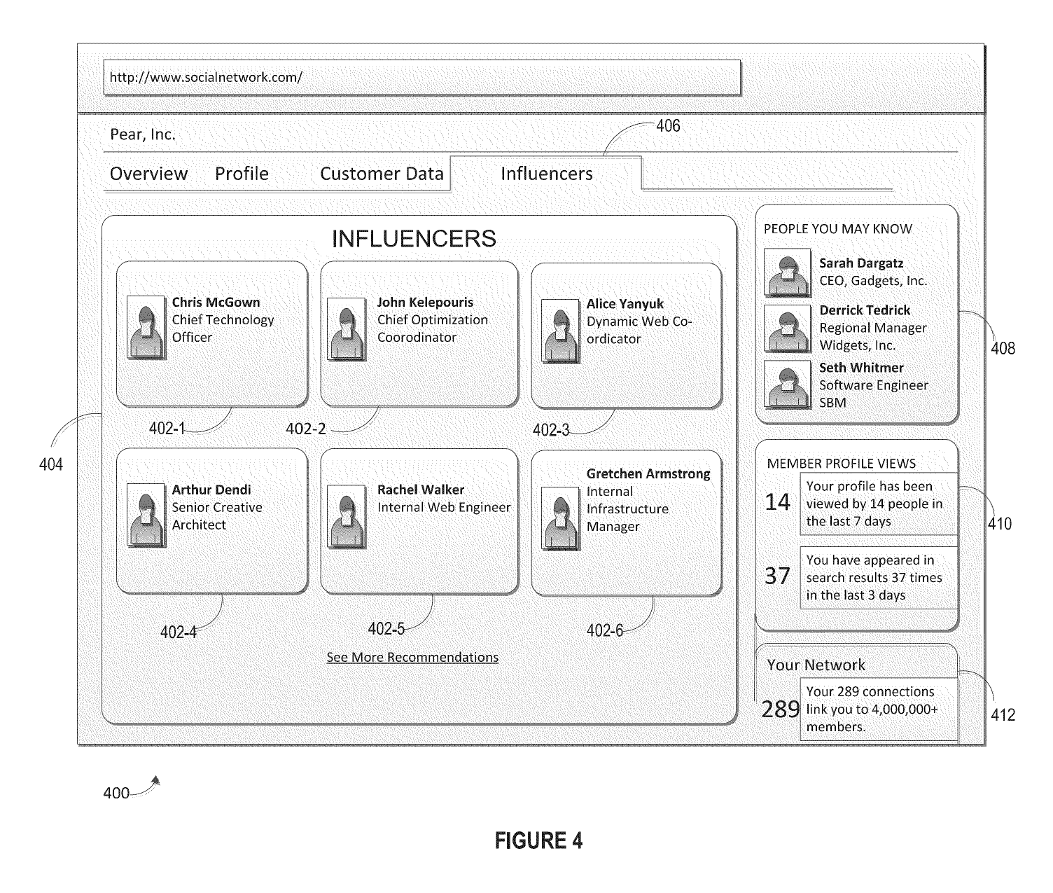

FIG. 4 is a member interface diagram illustrating an example of a user interface 400 or web page that incorporates top influencer service into a social networking service. The user interface 400 has information about an organization (Pear, Inc.) on an organization profile web page produced by the social networking service. As can be seen, the top influencers tab 406 has been selected, the general overview profile page has been removed, and an influencers page 404 has been displayed. The top influencers page 404 includes a plurality of members who have high influencer scores 402-1 to 402-6, wherein each member section displays a member name and includes basic information about the member, such as their names, titles, and basic contact information. Members can then select particular influencers to get additional information and the ability to contact the particular influencer.

The user interface 400 also includes information in side sections of the interface including a contact recommendation section 408, profile viewership statistic section 410, and a social graph statistic section 412.

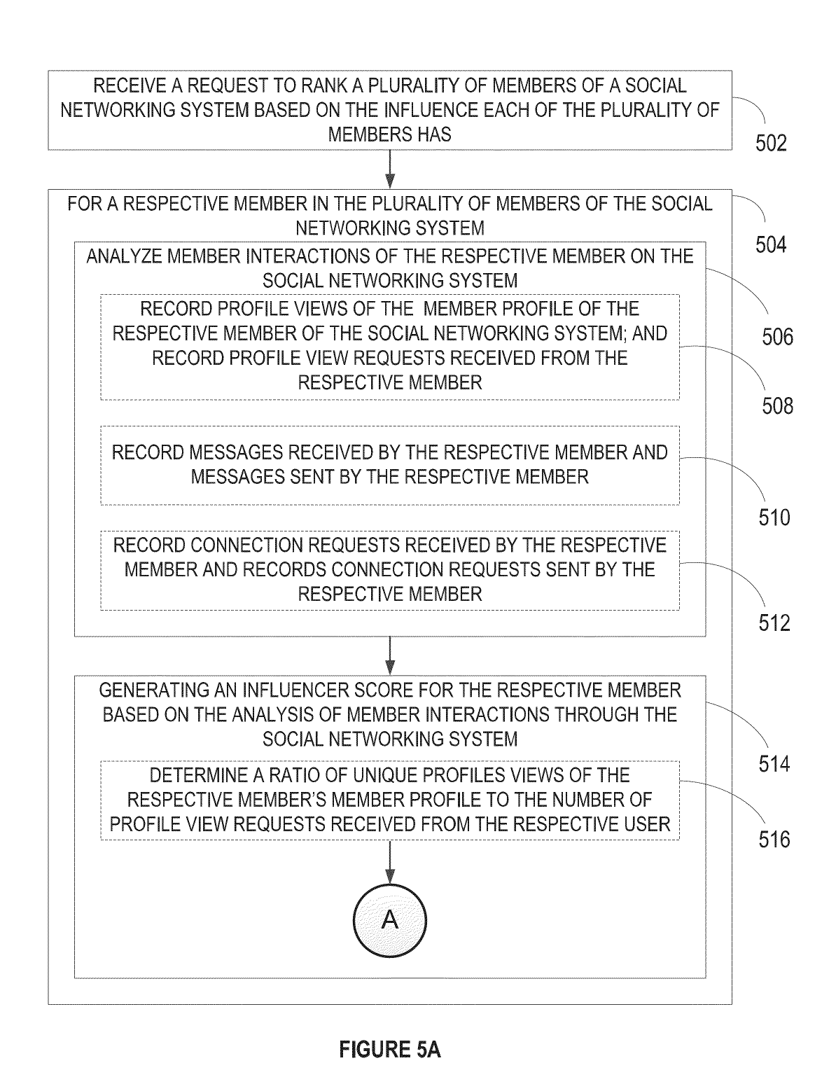

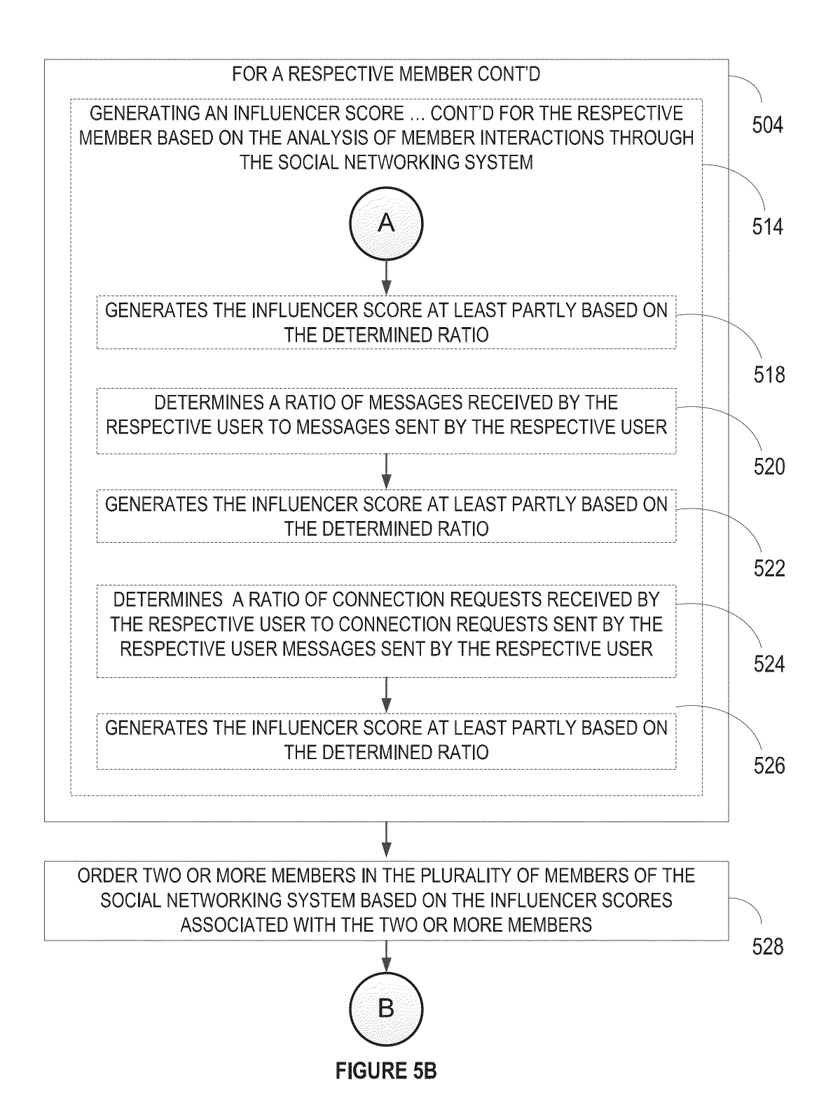

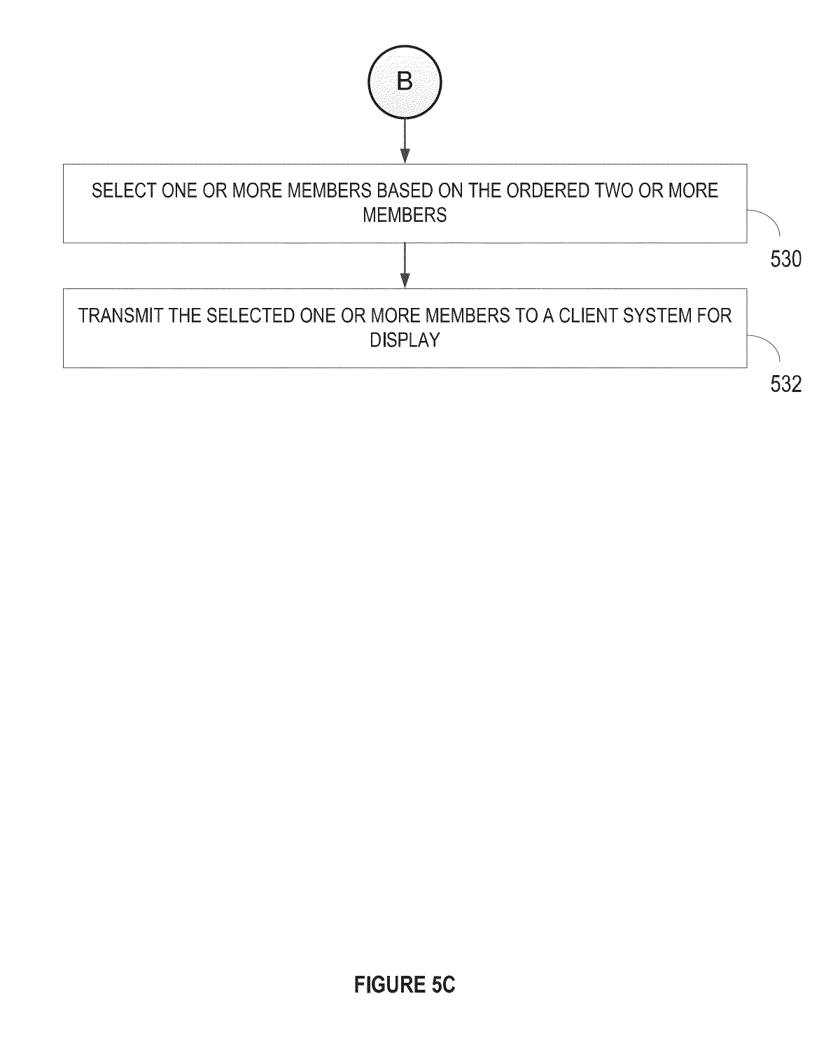

FIG. 5A is a flow diagram illustrating a process for generating lead recommendations, in accordance with some implementations. Each of the operations shown in FIG. 5A may correspond to instructions stored in a computer memory or computer readable storage medium. Optional operations are indicated by dashed lines (e.g., boxes with dashed-line borders). In some implementations, the method described in FIG. 5A is performed by the social networking system (e.g., system 120 in FIG. 1).

In some implementations, the method is performed at a social networking system (e.g., system 120 in FIG. 1) including one or more processors and memory storing one or more programs for execution by the one or more processors.

The social networking system (e.g., system 120 in FIG. 1) receives (502) a request to rank a plurality of members of a social networking system based on the influence each of the plurality of members has. In some example embodiments, the request to rank includes a target organization, and the plurality of members are associated with the target organization. For example, if a member visits a webpage associated with an organization, the client system (e.g., system 102 in FIG. 1) generates a request for a ranked list of influencers associated with that organization.

In some example embodiments, the request includes a specific number of requested members (e.g., the top three influencers), a minimum influencer score (e.g., every influencer with a score over the 0.75 if the influencer score is represented by a value between 0 and 1), or a top percentage of all influencers (the top 10% influencer scores). In other embodiments, the request includes a request for a specific type of influencer. For example, the request is from a job seeker who is interested in members who have a high influencer score in the area of hiring. In response, the social networking system (e.g., system 120 in FIG. 1) specifically analyzes the members in an organization based on human resource or hiring interactions.

In some example embodiments, the social networking system (e.g., system 120 in FIG. 1) selects one or more of the plurality of members included in the request to rank (e.g., employees of a specific company). For a respective member in the plurality of members (504) of the social networking system, the social networking system (e.g., system 120 in FIG. 1) analyzes (506) member interactions of the respective member on the social networking system. Member interactions include any messages, invitations (e.g., to an event), connection requests (e.g., to be added to the member's social graph), profile views, web page hits, clicks, or other interaction with the social networking system (e.g., system 120 in FIG. 1) or members of the social networking system (e.g., system 120 in FIG. 1). In some example embodiments, analyzing member interactions includes analyzing member interactions that take place through a third party system.

In some example embodiments, analyzing member interactions includes categorizing the interactions by when they occurred (more recent interactions are more important), what role the participants have with their respective organizations (e.g., a message from a salesman to a purchasing agent at another organization is categorized as a sales related message), the influencer score of each participant (e.g., receiving messages or profile views from a high influencer score member increases a member's own influencer score), and so on.

In some example embodiments, the social networking system (e.g., system 120 in FIG. 1) records (508) profile views of the member profile of the respective member of the social networking system and records profile view requests received from the respective member. For example, the social networking system (e.g., system 120 in FIG. 1) stores, for at least one first member, every member profile that the first member visits. When all the data from many members is collected, the social networking system (e.g., system 120 in FIG. 1) is able to identify patterns in members' profile viewing habits to identify members with popular profiles.

In some example embodiments, the social networking system (e.g., system 120 in FIG. 1) records (510) messages received by the respective member and messages sent by the respective member. For example, e-mails from one member to another are recorded. With enough data, the system (e.g., system 120 in FIG. 1) can determine which members receive an outsized number of messages from other members and determine which members are popular or have authority (e.g., a supervisor likely receives more messages from subordinates than any one of the subordinates receives on their own).

In some example embodiments, the social networking system (e.g., system 120 in FIG. 1) records (512) connection requests received by the respective member and records connection requests sent by the respective member. A connection request is a request to be added to a member's social graph. Aggregating connection request data over time will help determine which members are popular (those that receive a large number of connection requests). In some example embodiments, the ratio of connection requests received to connection requests sent (or connection requests received to connection requests accepted) is used as a component in one or more of a popularity score, an authority score, and an influencer score.

The social networking system (e.g., system 120 in FIG. 1) then generates (514) an influencer score for the respective member based on the analysis of member interactions through the social networking system. In some example embodiments, generating an influencer score for the respective member based on the analysis of member interactions through the social networking system includes determining (516) a ratio of unique profile views of the respective member's member profile to the number of profile view requests received from the respective member.

FIG. 5B is a flow diagram illustrating a process for using existing member profile and activity data to determine member influence levels within an organization, in accordance with some implementations. Each of the operations shown in FIG. 5B may correspond to instructions stored in a computer memory or computer readable storage medium. Optional operations are indicated by dashed lines (e.g., boxes with dashed-line borders). In some implementations, the method described in FIG. 5B is performed by the social networking system (e.g., system 120 in FIG. 1).

In some implementations, the method is performed at a social networking system (e.g., system 120 in FIG. 1) including one or more processors and memory storing one or more programs for execution by the one or more processors.

In some example embodiments, the server system (e.g., system 120 in FIG. 1) generates (518) the influencer score at least partly based on the determined ratio of messages received by the respective member to messages sent by the respective member. In some example embodiments, members with a high ratio of unique members who view their profile to profiles they have viewed generally have a higher influencer score.

In some example embodiments, the social networking system (e.g., system 120 in FIG. 1) determines (520) a ratio of messages received by the respective member to messages sent by the respective member. The social networking system (e.g., system 120 in FIG. 1) then generates (522) the influencer score at least partly based on the determined ratio.

In some example embodiments, the social networking system (e.g., system 120 in FIG. 1) determines (524) a ratio of connection requests received by the respective member to connection requests sent by the respective member. The social networking system (e.g., system 120 in FIG. 1) generates (526) the influencer score at least partly based on the determined ratio.

In some example embodiments, the social networking system (e.g., system 120 in FIG. 1) orders (528) two or more members in the plurality of members of the social networking system based on the influencer scores associated with the two or more members.

FIG. 5C is a flow diagram illustrating a process for using existing member profile and activity data to determine member influence levels within an organization in accordance with some implementations. Each of the operations shown in FIG. 5C may correspond to instructions stored in a computer memory or computer readable storage medium. In some implementations, the method described in FIG. 5C is performed by the social networking system (e.g., system 120 in FIG. 1).

In some implementations, the method is performed at a social networking system (e.g., system 120 in FIG. 1) including one or more processors and memory storing one or more programs for execution by the one or more processors.

In some example embodiments the social networking system (e.g., system 120 in FIG. 1) selects (530) one or more members based on the ordered two or more members. The social networking system (e.g., system 120 in FIG. 1) then transmits (532) the selected one or more members to a client system for display.

### Software Architecture

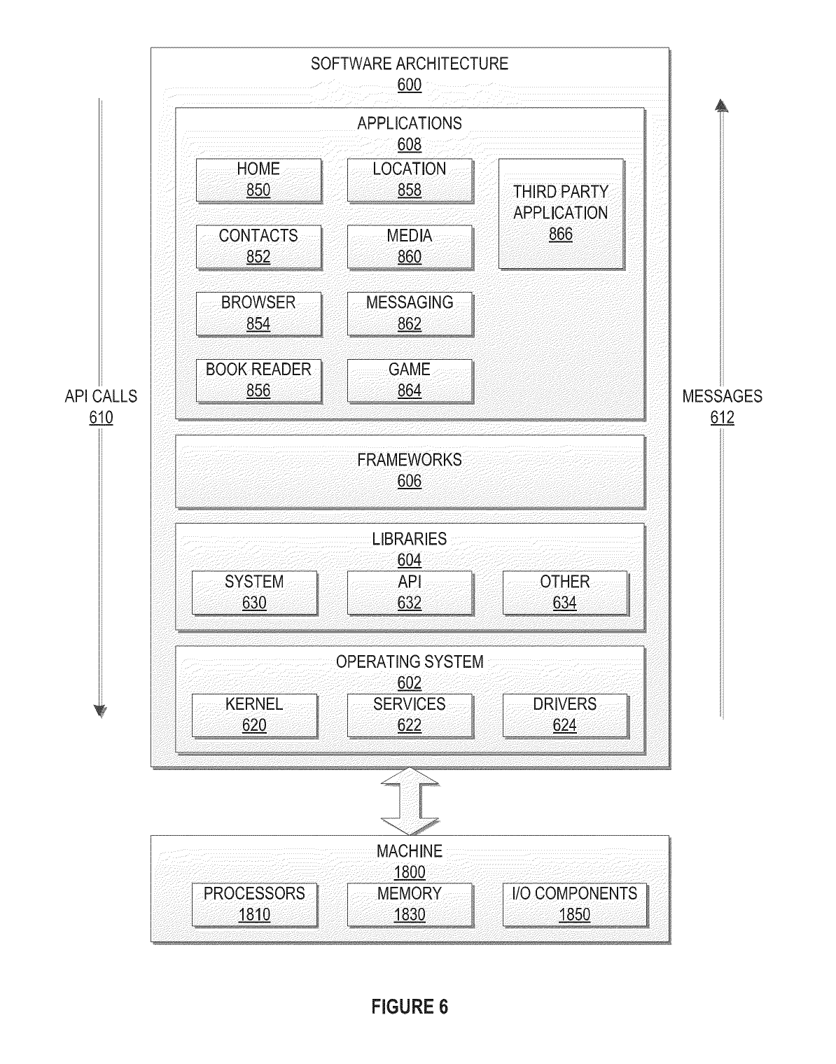

FIG. 6 is a block diagram illustrating an architecture of software 600, which may be installed on any one or more of devices of FIG. 1 (e.g., client device(s) 110). FIG. 6 is merely a non-limiting example of a software architecture and it will be appreciated that many other architectures may be implemented to facilitate the functionality described herein. The software 600 may be executing on hardware such as machine 1800 of FIG. 6 that includes processors 1810, memory 1830, and I/O components 1850. In the example architecture of FIG. 6, the software 600 may be conceptualized as a stack of layers where each layer may provide particular functionality. For example, the software 600 may include layers such as an operating system 602, libraries 604, frameworks 606, and applications 608. Operationally, the applications 608 may invoke API calls 610 through the software stack and receive messages 612 in response to the API calls 610.

The operating system 602 may manage hardware resources and provide common services. The operating system 602 may include, for example, a kernel 620, services 622, and drivers 624. The kernel 620 may act as an abstraction layer between the hardware and the other software layers. For example, the kernel 620 may be responsible for memory management, processor management (e.g., scheduling), component management, networking, security settings, and so on. The services 622 may provide other common services for the other software layers. The drivers 624 may be responsible for controlling and/or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 604 may provide a low-level common infrastructure that may be utilized by the applications 608. The libraries 604 may include system libraries 630 (e.g., C standard library) that may provide functions such as memory allocation functions, string manipulation functions, mathematic functions, and the like. In addition, the libraries 604 may include API libraries 632 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 604 may also include a wide variety of other libraries 634 to provide many other APIs to the applications 608.

The frameworks 606 may provide a high-level common infrastructure that may be utilized by the applications 608. For example, the frameworks 606 may provide various graphical user interface (GUI) functions, high-level resource management, high-level location services, and so forth. The frameworks 606 may provide a broad spectrum of other APIs that may be utilized by the applications 608, some of which may be specific to a particular operating system or platform.

The applications 608 include a home application 650, a contacts application 652, a browser application 654, a book reader application 656, a location application 658, a media application 660, a messaging application 662, a game application 664, and a broad assortment of other applications such as third party application 666. In a specific example, the third party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 666 may invoke the API calls 610 provided by the mobile operating system 602 to facilitate functionality described herein.

### Example Machine Architecture and Machine-Readable Medium

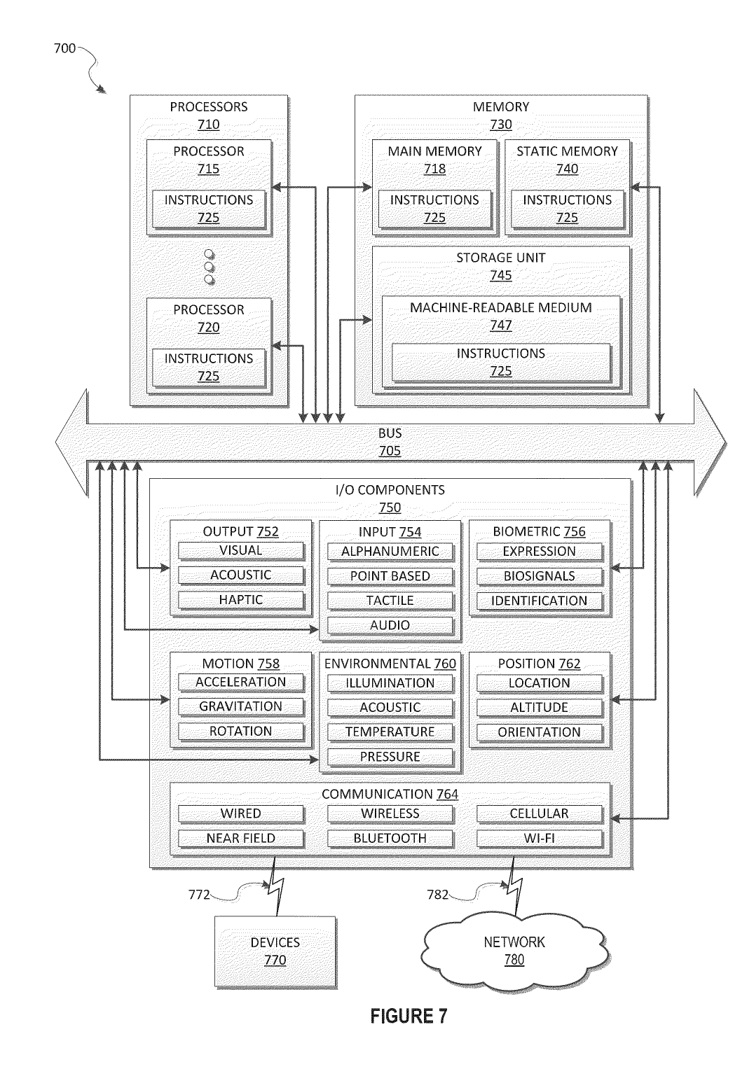

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 725 (e.g., software, a program, an application, an applet, an app, or other executable code) for causing the machine 700 to perform any one or more of the methodologies discussed herein may be executed. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but be not limited to, a server computer, a client computer, a (PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 725, sequentially or otherwise, that specify actions to be taken by machine 700. Further, while only a single machine 700 is illustrated, the term “machine” shall also be taken to include a collection of machines 700 that individually or jointly execute the instructions 725 to perform any one or more of the methodologies discussed herein.

The machine 700 may include processors 710, memory 730, and I/O components 750, which may be configured to communicate with each other via a bus 705. In an example embodiment, the processors 710 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 715 and processor 720, which may execute instructions 725. The term “processor” is intended to include multi-core processor that may comprise two or more independent processors (also referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory 730 may include a main memory 735, a static memory 740, and a storage unit 745 accessible to the processors 710 via the bus 705. The storage unit 745 may include a machine-readable medium 747 on which is stored the instructions 725 embodying any one or more of the methodologies or functions described herein. The instructions 725 may also reside, completely or at least partially, within the main memory 735, within the static memory 740, within at least one of the processors 710 (e.g., within the processor's cache memory), or any suitable combination thereof, during execution thereof by the machine 700. Accordingly, the main memory 735, static memory 740, and the processors 710 may be considered as machine-readable media 747.

As used herein, the term “memory” refers to a machine-readable medium 747 able to store data temporarily or permanently and may be taken to include, but not be limited to, random-access memory (RAM), read-only memory (ROM), buffer memory, flash memory, and cache memory. While the machine-readable medium 747 is shown in an example embodiment to be a single medium, the term “machine-readable medium” should be taken to include a single medium or multiple media (e.g., a centralized or distributed database, or associated caches and servers) able to store instructions 725. The term “machine-readable medium” shall also be taken to include any medium, or combination of multiple media, that is capable of storing instructions (e.g., instructions 725) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 750 may include a wide variety of components to receive input, provide and/or produce output, transmit information, exchange information, capture measurements, and so on. It will be appreciated that the I/O components 750 may include many other components that are not shown in FIG. 7. In various example embodiments, the I/O components 750 may include output components 752 and/or input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 750 may include biometric components 756, motion components 758, environmental components 760, and/or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 762 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 and/or devices 770 via coupling 782 and coupling 772, respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine and/or any of a wide variety of peripheral devices (e.g., a peripheral device couple via a USB).

Moreover, the communication components 764 may detect identifiers and/or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 764 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 725 may be transmitted and/or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 725 may be transmitted and/or received using a transmission medium via the coupling 772 (e.g., a peer-to-peer coupling) to devices 770. The term “transmission medium” shall be taken to include any intangible medium that is capable of storing, encoding, or carrying instructions 725 for execution by the machine 700, and includes digital or analog communications signals or other intangible medium to facilitate communication of such software.

Furthermore, the machine-readable medium 747 is non-transitory (in other words, not having any transitory signals) in that it does not embody a propagating signal. However, labeling the machine-readable medium 747 as “non-transitory” should not be construed to mean that the medium is incapable of movement; the medium should be considered as being transportable from one physical location to another. Additionally, since the machine-readable medium 747 is tangible, the medium may be considered to be a machine-readable device.

### TERM USAGE

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific implementations. However, the illustrative discussions above are not intended to be exhaustive or to limit the possible implementations to the precise forms disclosed. Many modifications and variations are possible in view of the above teachings. The implementations were chosen and described in order to best explain the principles involved and their practical applications, to thereby enable others skilled in the art to best utilize the various implementations with various modifications as are suited to the particular use contemplated.

It will also be understood that, although the terms first, second, and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

1. (canceled)

2. (canceled)

3. (canceled)

4. (canceled)

5. The method of claim 2, wherein generating an influencer score for the respective member based on the analysis of member interactions through the social networking system includes:
determining a ratio of unique profile views of the respective member's member profile to the number of profile view requests received from the respective member; and
generating the influencer score at least partly based on the determined ratio.

6. (canceled)

7. (canceled)

8. (canceled)

9. (canceled)

10. (canceled)

11. (canceled)

12. (canceled)

13. (canceled)

14. The system of claim 11, wherein the instructions for generating an influencer score for the respective member based on the analysis of member interactions through the social networking system further includes instructions for:
determining a ratio of unique profile views of the respective member's member profile to the number of profile view requests received from the respective member; and
generating the influencer score at least partly based on the determined ratio.

15. The system of claim 14, wherein the instructions for generating an influencer score for the respective member based on the analysis of member interactions through the social networking system further includes instructions for:
determining a ratio of messages received by the respective member to messages sent by the respective member; and
generating the influencer score at least partly based on the determined ratio.

16. (canceled)

17. (canceled)

18. (canceled)

19. The non-transitory computer readable storage medium of claim 17, wherein the instructions for generating an influencer score for the respective member based on the analysis of member interactions through the social networking system further includes instructions for:
determining a ratio of unique profile views of the respective member's member profile to the number of profile view requests received from the respective member; and
generating the influencer score at least partly based on the determined ratio.

20. The non-transitory computer readable storage medium of claim 19, wherein the instructions for generating an influencer score for the respective member based on the analysis of member interactions through the social networking system further includes instructions for:
determining a ratio of messages received by the respective member to messages sent by the respective member; and
generating the influencer score at least partly based on the determined ratio.
